(19) United States
(12) Patent Application Publication
(10) Pub. No.: US 2015/0086801 A1
(43) Pub. Date: Mar. 26, 2015

(54) METHOD FOR MANUFACTURING COMPLEX FOR CARBON DIOXIDE SEPARATION, COMPLEX FOR CARBON DIOXIDE SEPARATION, AND MODULE FOR CARBON DIOXIDE SEPARATION

(71) Applicant: FUJIFILM CORPORATION, Tokyo (JP)

(72) Inventors: Daisuke HIRAKI, Kanagawa (JP); Kenichi ISHIZUKA, Kanagawa (JP)

(21) Appl. No.: 14/558,723

(22) Filed: Dec. 3, 2014

Related U.S. Application Data
(63) Continuation of application No. PCT/JP2013/065490, filed on Jun. 4, 2013.

(30) Foreign Application Priority Data
Jul. 11, 2012 (JP) 2012-155924

(51) Int. Cl. B01J 20/32; B01J 20/26; B01J 20/04; B01J 20/16; B01J 20/08; B01J 20/02; B01J 20/12; B01J 20/30; B01J 20/10

(52) U.S. Cl. CPC B01J 20/3276; B01J 20/3289; B01J 20/3225; B01J 20/321; B01J 20/3078; B01J 20/264; B01J 20/043; B01J 20/103; B01J 20/08; B01J 20/041; B01J 20/02; B01J 20/12; B01J 20/165; B01J 20/261; B01J 20/262
USPC 428/500; 427/385.5; 427/374.1; 252/184

(57) ABSTRACT

A method for manufacturing a complex for carbon dioxide separation, the complex for carbon dioxide separation including a support and a carbon dioxide separation layer on the support, and the method including: applying, on the support, a coating liquid for forming the carbon dioxide separation layer including: a water-absorbing polymer, an alkali metal salt, and a filler having a density lower than a density of the alkali metal salt, a new Mohs hardness of 2 or greater, and a volume average particle diameter that is 30% or less of a thickness of the carbon dioxide separation layer; and drying the coating liquid applied for forming the carbon dioxide separation layer to obtain the carbon dioxide separation layer.

### CROSS-REFERENCE TO RELATED APPLICATION

This application is a Continuation of PCT International Application No. PCT/JP2013/065490, filed Jun. 4, 2013, which claims priority under 35 U.S.C. §119(a) to Japanese Patent Application No. 2012-155924 filed Jul. 11, 2012. Each of the above applications is hereby expressly incorporated by reference, in its entirety, into the present application.

### BACKGROUND OF THE INVENTION

1. Technical Field

The present invention relates to a method for manufacturing a complex for carbon dioxide separation, a complex for carbon dioxide separation, and a module for carbon dioxide separation.

2. Background Art

In recent years, development of techniques for selectively separating carbon dioxide in a mixed gas is advancing. For example, as a countermeasure for global warming, a technique of collecting carbon dioxide in exhausted gas and condensing it, and a technique of reforming hydrocarbon into hydrogen and carbon monoxide (CO) by steam reforming, further allowing the carbon monoxide to react with steam to form carbon dioxide and hydrogen, and excluding the carbon dioxide by using a membrane which is selectively permeable to carbon dioxide, thereby obtaining gas for fuel cells or the like, which includes hydrogen as a main component, have been developed.

Meanwhile, regarding separation of carbon dioxide, an amine absorption method, in which adsorption and desorption are repeated by amines, is a general method and has been widely used. However, this method is disadvantageous in that a huge installation area is needed for the facilities and, in addition, it is necessary to repeat increasing pressure/decreasing pressure and lowering temperature/elevating temperature at the time of adsorption/desorption, which needs a large amount of energy. Further, the capacity of the system is determined at the time of planning, and thus, it is not easy to increase or decrease the capacity of the system once formed. In contrast, a membrane separation method is a method of performing separation naturally by utilizing the component pressure of carbon dioxide in the two regions separated by a separation membrane and is advantageous in that consumption of energy is low and the installation area is small. Further, increase or decrease in the capacity of the system can be conducted by increasing or decreasing the number of filter units and, therefore, it is possible to provide a system having excellent scalability; accordingly, the membrane separation method has recently attracted attention.

Carbon dioxide separation membranes can be roughly classified into so-called accelerated transport membranes, in which a carbon dioxide carrier is included in the membrane and carbon dioxide is transported to the opposite side of the membrane by this carrier, and so-called dissolution diffusion membranes, with which separation is performed by utilizing the difference in solubility with respect to the membrane and the difference in diffusivity in the membrane, between carbon dioxide and the substance to be subject to separation.

Since a dissolution diffusion membrane is used to perform separation based on the solubilities of carbon dioxide and the substance to be subject to separation with respect to the membrane and the diffusion speeds, the degree of separation is determined unequivocally when the material and physical properties of the membrane are determined, and further, since the permeation speed increases as the thickness of the membrane gets thinner, the dissolution diffusion membrane is generally produced as a thin membrane having a thickness of 1 μm or less, by using a layer separation method, an interfacial polymerization method, or the like.

In contrast, in an accelerated transport membrane, by the addition of a carbon dioxide carrier to the membrane, the solubility of carbon dioxide is drastically increased, and transportation is carried out under a high concentration environment. Accordingly, the accelerated transport membrane is characterized in that, in general, the degree of separation with respect to the substance to be separated is higher and the permeation speed of carbon dioxide is higher, as compared with a dissolution diffusion membrane. Further, since the concentration of carbon dioxide in the membrane is high, the diffusion of carbon dioxide in the membrane rarely becomes a rate-limiting factor, and in the sense of increasing the degree of separation with respect to the substance to be separated, it is more preferable that the accelerated transport membrane is a thick membrane having a thickness of 10 μm or more.

For example, in Japanese Patent Application Laid-Open (JP-A) No. 2009-195900, a carbon dioxide separation apparatus has been proposed in which a gel layer, which is obtained by adding an additive including cesium carbonate or cesium hydrogencarbonate or cesium hydroxide to a vinyl alcohol-acrylic acid copolymer gel membrane, is provided on a hydrophilic porous membrane to form a carbon dioxide accelerated transport membrane, and a source gas including at least carbon dioxide and steam as well as a certain main component of gas is supplied to the surface of the source side of the carbon dioxide accelerated transport membrane at a supply temperature of 100° C. or higher, and then the carbon dioxide, which has been permeated through the carbon dioxide accelerated transport membrane, is taken out from the surface of the permeation side.

### SUMMARY OF INVENTION

### Technical Problem

In carbon dioxide separation membranes equipped with a gel membrane, since the gel membrane does not have sufficient strength, it was difficult to achieve so-called continuous roll to roll (R to R) production, which aims at improvement in productivity, and in which a gel membrane is coated on a support and the assembly thus formed is wound to use this assembly in the next process.

The present inventors have conducted investigations and, as a result, it has become clear that, since the gel membrane includes a large amount of cesium carbonate that serves as a carbon dioxide carrier, the membrane strength of the above-described carbon dioxide separation membrane described in JP-A No. 2009-195900 is weak, and defects are likely to occur during the manufacturing process, for example, at the time of winding up the membrane into a roll or the like.

Under such circumstances, development of a method for manufacturing a complex for carbon dioxide separation, which has a high membrane strength, while exhibiting a high gas separation characteristic with respect to carbon dioxide, and which is capable of continuous production, is desired.

An aspect of the invention is to provide a manufacturing method capable of manufacturing a complex for carbon dioxide separation, which has a high membrane strength and is capable of continuous production; a complex for carbon dioxide separation having a high membrane strength; and a module for carbon dioxide separation equipped with the complex for carbon dioxide separation.

Specific means for addressing the above problems are as follows.

<1> A method for manufacturing a complex for carbon dioxide separation, the complex for carbon dioxide separation including a support and a carbon dioxide separation layer on the support, and the method including: applying, on the support, a coating liquid for forming the carbon dioxide separation layer, the coating liquid including: a water-absorbing polymer, an alkali metal salt, and a filler having a density lower than a density of the alkali metal salt, a new Mohs hardness of 2 or greater, and a volume average particle diameter that is 30% or less of a thickness of the carbon dioxide separation layer; and drying the applied coating liquid for forming the carbon dioxide separation layer to obtain the carbon dioxide separation layer.

<2> The method for manufacturing a complex for carbon dioxide separation according to the item <1>, wherein 60% by mass or more of a total mass of the filler exist within a region from a surface on an opposite side from a surface that contacts the support to a position at a depth of 50% in a film thickness direction of the carbon dioxide separation layer.

<3> The method for manufacturing a complex for carbon dioxide separation according to the item <1> or the item <2>, wherein a membrane surface scratch damage initiation load at a surface of the carbon dioxide separation layer, when a sapphire needle having a diameter of 0.5 mm is used, is 20 g or more.

<4> The method for manufacturing a complex for carbon dioxide separation according to anyone of the items <1> to <3>, wherein the filler is at least one selected from the group consisting of an inorganic filler and an organic filler.

<5> The method for manufacturing a complex for carbon dioxide separation according to anyone of the items <1> to <4>, wherein the filler is at least one of (i) an inorganic filler containing silica, alumina, aluminium hydroxide, magnesium oxide, magnesium hydroxide, calcium carbonate, boron nitride, clay, kaolin or mica, or (ii) an organic filler containing an acrylic resin particle or a polystyrene particle.

<6> The method for manufacturing a complex for carbon dioxide separation according to anyone of the items <1> to <5>, wherein the water-absorbing polymer is at least one polymer selected from the group consisting of a polymer including a repeating unit derived from vinyl alcohol, a polymer including a repeating unit derived from an ethylene imine, and a polymer including a repeating unit derived from an acrylic acid.

<7> The method for manufacturing a complex for carbon dioxide separation according to anyone of the items <1> to <6>, wherein the water-absorbing polymer is a polymer including a repeating unit derived from vinyl alcohol.

<8> The method for manufacturing a complex for carbon dioxide separation according to anyone of the items <1> to <7>, wherein the water-absorbing polymer is a vinyl alcohol-acrylic acid copolymer.

<9> The method for manufacturing a complex for carbon dioxide separation according to anyone of the items <1> to <8>, wherein the coating liquid for forming the carbon dioxide separation layer further includes a polysaccharide at a content of from 0.1% by mass to 8% by mass with respect to a total mass of the coating liquid for forming a carbon dioxide separation layer.

<10> The method for manufacturing a complex for carbon dioxide separation according to the item <9>, wherein the polysaccharide is an agar.

<11> The method for manufacturing a complex for carbon dioxide separation according to anyone of the items <1> to <10>, wherein the coating liquid for forming the carbon dioxide separation layer further includes a crosslinking agent at a content of from 0.001% by mass to 1% by mass with respect to a total mass of the coating liquid for forming a carbon dioxide separation layer.

<12> The method for manufacturing a complex for carbon dioxide separation according to the item 11, wherein the crosslinking agent is glutaraldehyde.

<13> The method for manufacturing a complex for carbon dioxide separation according to anyone of the items <1> to <12>, wherein the applying is coating, on the support in a single layer, the coating liquid for forming the carbon dioxide separation layer, or coating, on the support in a multilayer, a coating liquid including the water-absorbing polymer and the alkali metal salt, and the coating liquid for forming the carbon dioxide separation layer, in this order.

<14> The method for manufacturing a complex for carbon dioxide separation according to anyone of the items <1> to <13>, wherein the method further includes cooling the coating liquid for forming the carbon dioxide separation layer, obtained on the support in the applying, to a temperature in a range of from 1° C. to 35° C., before the drying.

<15> A complex for carbon dioxide separation, the complex being obtained by the method for manufacturing a complex for carbon dioxide separation according to anyone of the items <1> to <14>.

<16> A complex for carbon dioxide separation, the complex including: a carbon dioxide separation layer, including: a water-absorbing polymer, an alkali metal salt, and a filler having a density lower than a density of the alkali metal salt, and a new Mohs hardness of 2 or greater, wherein a volume average particle diameter of the filler is 30% or less of a thickness of a carbon dioxide separation layer.

<17> The complex for carbon dioxide separation according to the item <16>, wherein 60% by mass or more of a total mass of the filler exist within a region from a surface on an opposite side from a surface that contacts the support to a position at a depth of 50% in a film thickness direction of the carbon dioxide separation layer.

<18> A carbon dioxide separation module, including a complex for carbon dioxide separation, the complex including: a carbon dioxide separation layer including: a water-absorbing polymer, an alkali metal salt, and a filler having a density lower than a density of the alkali metal salt, and a new Mohs hardness of 2 or greater, wherein a volume average particle diameter of the filler is 30% or less of a thickness of a carbon dioxide separation layer.

According to the invention, a manufacturing method capable of manufacturing a complex for carbon dioxide separation, which has a high membrane strength and is capable of continuous production; a complex for carbon dioxide separation having a high membrane strength; and a module for carbon dioxide separation equipped with the complex for carbon dioxide separation can be provided.

### BRIEF DESCRIPTION OF DRAWINGS

FIG. 1 is a schematic diagram showing a constitutional example of an apparatus used in the method for manufacturing a complex for carbon dioxide separation according to the invention.

FIG. 2 is a schematic diagram showing a constitutional example of a complex for carbon dioxide separation according to the invention, which has a carbon dioxide separation layer.

### DESCRIPTION OF EMBODIMENTS

Hereinafter, the invention is described in detail.

Note that, a numerical range expressed by using the term “to” in this specification represents a range including numerical values described in front of and behind “to” as the minimum value and the maximum value, respectively.

In this specification, the term “process” includes not only an independent process, but also a case which cannot be clearly distinguished from other process, as far as the predetermined action of the process is achieved.

In this specification, in a case in which plural substances corresponding to a component are present in a composition, the amount of the component in the composition means the total amount of the plural substances that are present in the composition, unless otherwise specified.

In this specification, the term “carbon dioxide separation layer” means a substance obtained by drying the coating liquid for forming a carbon dioxide separation layer described below.

In this specification, the term “complex for carbon dioxide separation” means a substance that has a support and a carbon dioxide separation layer.

The complex for carbon dioxide separation in the invention includes a filler (hereinafter, may be abbreviated as “specific filler”) having a density lower than the density of the alkali metal salt, a new Mohs hardness of 2 or more, and a volume average particle diameter that is 30% or less of the thickness of the carbon dioxide separation layer.

In general, when a filler is compounded in a complex for carbon dioxide separation, the density of the complex for carbon dioxide separation is lowered, so that the complex for carbon dioxide separation becomes brittle. Therefore, in a complex for carbon dioxide separation containing a filler, defects such as cracks or the like are likely to occur in the manufacturing process, for example, at the time of winding up, winding off, or the like.

On the contrary, in the complex for carbon dioxide separation in the invention, since the complex for carbon dioxide separation includes a specific filler, the specific filler is unevenly distributed at the surface of the carbon dioxide separation layer, and thus, it is presumed that the membrane strength of the complex for carbon dioxide separation can be enhanced.

Further, in the complex for carbon dioxide separation in the invention, since the specific filler is unevenly distributed at the surface of the carbon dioxide separation layer, the denseness of the lower layer portion is ensured, and thus, it is presumed that a high gas separation characteristic with respect to carbon dioxide can also be maintained.

<Method for Manufacturing Complex for Carbon Dioxide Separation>

The method for manufacturing a complex for carbon dioxide separation of the invention (hereinafter, if appropriate, referred to as the “manufacturing method of the invention”.) includes an application process of applying, on a support, a coating liquid for forming a carbon dioxide separation layer, the coating liquid containing a water-absorbing polymer, an alkali metal salt, and a filler having a density lower than the density of the alkali metal salt, a new Mohs hardness of 2 or more, and a volume average particle diameter that is 30% or less of the thickness of the carbon dioxide separation layer; and a drying process of drying the coating liquid for forming a carbon dioxide separation layer, which has been applied, to obtain a carbon dioxide separation layer.

In the following, the manufacturing method of the invention is specifically explained with reference to the drawings, if appropriate.

(Entire Configuration of Manufacturing Apparatus Example)

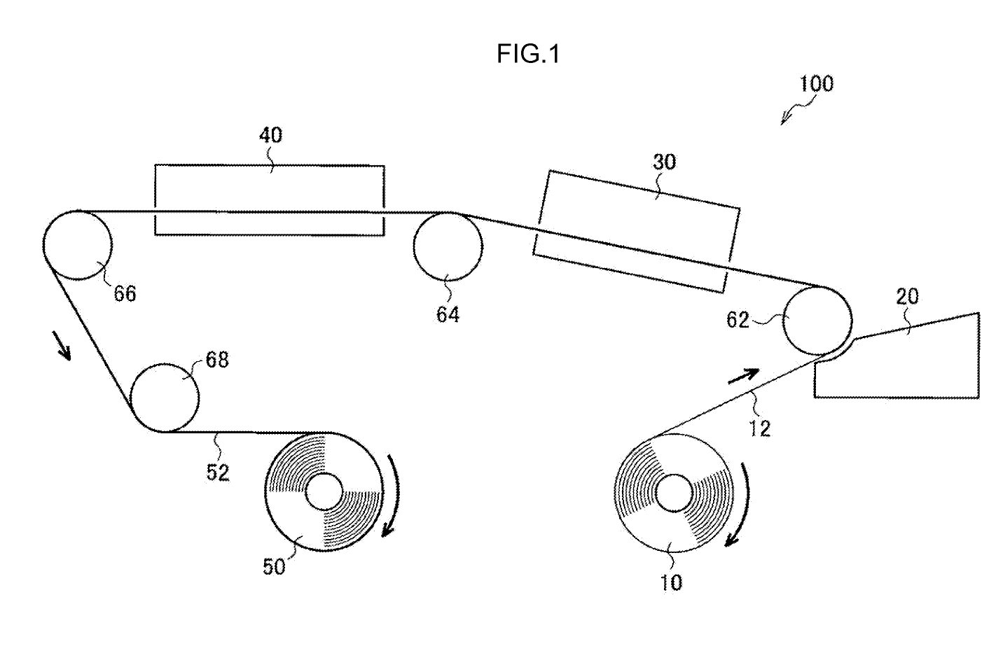

FIG. 1 schematically shows an example of a configuration of an apparatus used in the manufacturing method of the invention. This apparatus 100 is equipped with a let-off roll 10 that sends off the belt-shaped support 12, a coater 20 with which the coating liquid for forming a carbon dioxide separation layer is coated on the support 12, a cooling section 30 where the coating liquid for forming a carbon dioxide separation layer, which has been coated, is gelated, a drying section 40 where the gel membrane is dried to obtain a carbon dioxide separation layer, and a take-up roll 50 that winds up the complex 52 for carbon dioxide separation having a layered carbon dioxide separation layer. Further, conveying rolls 62, 64, 66, and 68 for conveying the support 12 to each of the sections 20, 30, 40, and 50 are arranged.

In this specification, the term “gelation” means realizing high viscosity, and does not necessarily represent the state in which fluidity is lost at all.

By the use of the apparatus 100 having a configuration as described above, roll-to-roll (which may be abbreviated as “R to R”) can be carried out, that is, the support 12 can be sent off from the let-off roll 10, and while conveying the support 12, an application process, a cooling process, and a drying process can be carried out in order, and then the obtained complex 52 for carbon dioxide separation can be wound up onto the take-up roll 50, and further, by carrying out a crosslinking process, a complex 52 for carbon dioxide separation having an excellent gas separation characteristic can be manufactured successively and efficiently. Note that, the crosslinking process may be carried out before winding up the membrane obtained after the drying process onto the take-up roll 50, or may be carried out after winding up into a roll, or may be carried out at the time of preparation of the coating liquid for forming a carbon dioxide separation layer, before the application process.

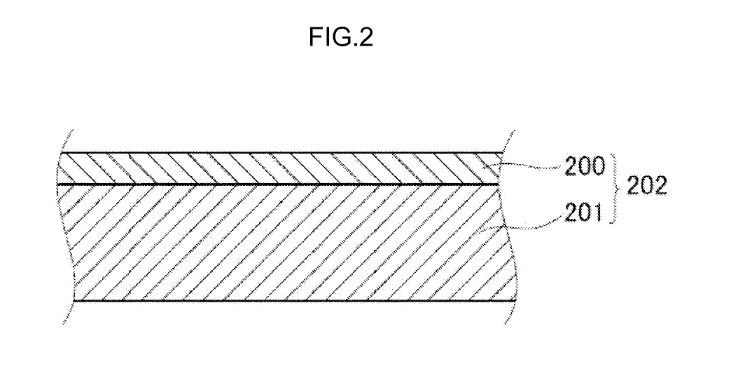

FIG. 2 schematically shows an example of a configuration of a complex 202 for carbon dioxide separation, which is equipped with a support 201 and a carbon dioxide separation layer 200 that is produced by using the coating liquid for forming a carbon dioxide separation layer according to the invention. In this complex 202 for carbon dioxide separation, the carbon dioxide separation layer 200 is formed on the support 201 which is permeable to carbon dioxide. In an apparatus equipped with the complex 202 for carbon dioxide separation as described above, by supplying a mixed gas including carbon dioxide to the carbon dioxide separation layer side of the complex 202 for carbon dioxide separation, along with providing a difference in pressure such that the pressure at the mixed gas supplying side becomes lower than the pressure at the permeation side, the carbon dioxide in the mixed gas passes through the carbon dioxide separation layer 200 and the support 201, whereby gas separation can be conducted.

In the following, the process for manufacturing the complex for carbon dioxide separation is explained in detail.

[Application Process]

In the application process, a coating liquid for forming a carbon dioxide separation layer (hereinafter, if appropriate, referred to as “coating liquid”), the coating liquid containing a water-absorbing polymer, an alkali metal salt, and a filler having a density lower than the density of the alkali metal salt, a new Mohs hardness of 2 or more, and a volume average particle diameter that is 30% or less of the thickness of the carbon dioxide separation layer, is applied onto the support.

The application process may be a process of performing monolayer coating by coating the coating liquid for forming a carbon dioxide separation layer on a support, or may be a process of performing multilayer coating by coating, on a support, a coating liquid containing a water-absorbing polymer and an alkali metal salt and the coating liquid for forming a carbon dioxide separation layer in this order.

Alternatively, the application process may be a process of coating the coating liquid for forming a carbon dioxide separation layer on a temporary support, and then transferring the coating liquid for forming a carbon dioxide separation layer onto a support.

In the process of performing multilayer coating, the coating liquid for forming a carbon dioxide separation layer may be coated after coating the coating liquid containing a water-absorbing polymer and an alkali metal salt on the support, or the coating liquid containing a water-absorbing polymer and an alkali metal salt and the coating liquid for forming a carbon dioxide separation layer may be coated simultaneously.

In the application process, after preparing the coating liquid for forming a carbon dioxide separation layer described below, the belt-shaped support 12 is sent off from the let-off roll 10, and is conveyed to the coating section 20, and the coating liquid is applied onto the support 12.

When the temperature of the coating liquid until the coating liquid is used in the application process is too low, the water-absorbing polymer may be deposited (salted out), so that application to a support may become difficult, or in a case in which a polysaccharide is contained in the coating liquid, the viscosity of the coating liquid may be increased due to the solidification function of the polysaccharide, so that the variation in film thickness may become more significant.

Therefore, it is preferable to keep the temperature of the coating liquid within a period after the preparation of the coating liquid until the application of the coating liquid to the support, such that salting-out or the like does not occur. The temperature of the coating liquid in the application process may be determined according to the composition or the concentration, such that salting-out or the like does not occur; however, when the temperature is too high, a large amount of water may evaporate from the coating liquid to change the composition concentration of the coating liquid. Further, there is concern that salting-out or the like may proceed partially. Thus, it is preferable to keep the temperature of the coating liquid within a range of from about 40° C. to about 95° C., it is more preferable to keep the temperature within a range of from 45° C. to 90° C., and it is still more preferable to keep the temperature within a range of from 50° C. to 85° C.

The support 12 is a substance that supports the complex for carbon dioxide separation. The support is not particularly limited as long as the support has carbon dioxide permeability, a complex for carbon dioxide separation can be formed thereon by coating the coating liquid for forming a carbon dioxide separation layer (coating liquid) according to the invention, and the support can support this membrane. A porous support having favorable carbon dioxide permeability is preferable. For the porous support, a substance capable of forming a carbon dioxide separation layer in a desired form by coating the coating liquid is preferable.

As the material of the support 12, paper, high quality paper, coated paper, cast coated paper, synthetic paper, and further, cellulose, polyester, polyolefin, polyamide, polyimide, polysulfone, aramid, polycarbonate, metals, glass, ceramics, and the like can be preferably used. More specifically, resin materials such as polypropylene, polyethylene, polystyrene, polyphenylsulfide, polyether imide, polyether ether ketone, polysulfone, polyether sulfone, polyethylene terephthalate, polytetrafluoroethylene, or polyvinylidene fluoride can be preferably used. Among them, polyolefin and fluorides thereof can be particularly preferably used from the viewpoint of stability over time.

Regarding the form of the support 12, woven fabric, non-woven fabric, porous membrane, or the like can be adopted. In general, a support having a high self-supporting property and a high porosity can be preferably used. A membrane filter of polysulfone or cellulose, an interfacial polymerization thin membrane of polyamide or polyimide, and an expanded porous membrane of polytetrafluoroethylene or high molecular weight polyethylene have high porosity, exhibit reduced inhibition in carbon dioxide diffusion, and are preferable from the viewpoints of strength, production suitability, and the like. Among them, an expanded membrane of polytetrafluoroethylene (PTFE) is particularly preferable.

These supports may be used singly, but a composite membrane which is integrated with a reinforcing support can also be used preferably.

As the support, other than the organic materials described above, an inorganic material or an organic-inorganic hybrid material may be used. Examples of an inorganic support include porous bases including ceramics as the main component. By including ceramics as the main component, heat resistance, corrosion resistance, and the like are excellent, and mechanical strength can be enhanced. There is no particular limitation on the kind of ceramics, and any generally used ceramics can be employed. Examples include alumina, silica, silica-alumina, mullite, cordierite, and zirconia. Further, adjustment may be conducted by producing a composite material made from two or more kinds of ceramics, or ceramics and metal, or by producing a composite material made from ceramics and an organic compound.

When the support 12 is too thick, gas permeability lowers, and when the support is too thin, the strength is not sufficient. Thus, the thickness of the support is preferably from 30 μm to 500 μm, more preferably from 50 μm to 400 μm, and particularly preferably from 50 μm to 350 μm. In the manufacture according to a roll-to-roll method, in order to prevent the occurrence of distortion or fracture of the support, for example, it is preferable that the tensile strength of the porous support is 10 N/10 mm or more (at a tensile speed of 10 mm/min).

Regarding the conveyance speed of the support 12, although it depends on the type of the support 12, the viscosity of the coating liquid for forming a carbon dioxide separation layer (coating liquid), and the like, when the conveyance speed of the support is too high, the film thickness uniformity of the coated film in the application process may be deteriorated, and when the conveyance speed is too low, the productivity lowers and, in addition, the viscosity of the coating liquid for forming a carbon dioxide separation layer may increase before the cooling process, so that the uniformity of the coated film may be deteriorated. The conveyance speed of the support 12 may be determined according to type of the support 12, the viscosity of the coating liquid for forming a carbon dioxide separation layer, and the like, while considering the above points, but the conveyance speed is preferably 1 m/min or higher, more preferably from 2 m/min to 200 m/min, and particularly preferably from 3 m/min to 200 m/min.

Regarding the method of coating the coating liquid for forming a carbon dioxide separation layer, a conventionally known method can be employed. Examples include a curtain flow coater, an extrusion die coater, an air doctor coater, a blade coater, a rod coater, a knife coater, a squeeze coater, a reverse roll coater, and a bar coater. Particularly, from the viewpoints of the film thickness uniformity, the coating amount, and the like, an extrusion die coater is preferable.

Regarding the coating amount of the coating liquid for forming a carbon dioxide separation layer, although it depends on the composition of the coating liquid, the concentration, and the like, when the coating amount per unit area is too small, a pore may be formed in the membrane, in a case in which the volume of the membrane is decreased during the drying process described below. When a pore is formed in the membrane, the membrane becomes a defective product and cannot be used as a complex for carbon dioxide separation. In addition, when the coating amount per unit area is too small, the strength as a complex for carbon dioxide separation may become insufficient. Meanwhile, when the coating amount is too large, variation in film thickness may become more significant, or the film thickness of the carbon dioxide separation layer to be obtained may become too large, so that the permeability of carbon dioxide may be deteriorated.

From the viewpoints described above, it is preferable to adjust the coating amount such that the thickness of the carbon dioxide separation layer obtained in the drying process described below is from 1 μm to 1000 μm, more preferably from 2 μm to 1000 μm, and particularly preferably from 3 μm to 1000 μm.

In the following, the components contained in the coating liquid for forming a carbon dioxide separation layer are described.

(Water-Absorbing Polymer)

The water-absorbing polymer contained in the coating liquid for forming a carbon dioxide separation layer according to the invention is a polymer that functions as a binder, and when used in a complex for carbon dioxide separation, the water-absorbing polymer retains moisture and allows the function of separation of carbon dioxide by an alkali metal salt to be exhibited, as well as ensures the denseness of the membrane in order to prevent permeation of gas other than carbon dioxide. Accordingly, in the invention, as the water-absorbing polymer, a substance that uniformly dissolves or disperses in water and can form a dense membrane after coating and drying can preferably be used.

From the viewpoint that the complex for carbon dioxide separation has a high water absorbing property (moisture retaining property), the water-absorbing polymer is preferably a polymer having a high water absorbing property, and it is preferable to have a water absorbing property such that the amount of physiological saline absorbed is 0.5 g/g or more, it is more preferable to have a water absorbing property such that the amount of physiological saline absorbed is 1 g/g or more, it is still more preferable to have a water absorbing property such that the amount of physiological saline absorbed is 5 g/g or more, it is particularly preferable to have a water absorbing property such that the amount of physiological saline absorbed is 10 g/g or more, and it is most preferable to have a water absorbing property such that the amount of physiological saline absorbed is 20 g/g or more.

As the water-absorbing polymer contained in the coating liquid for forming a carbon dioxide separation layer in the invention, a conventionally known hydrophilic polymer can be used. From the viewpoints of water absorbing property, film forming property, strength, and the like, for example, polyvinyl alcohols, polyacrylic acids, polyethylene oxides, water-soluble celluloses, starches, alginic acids, chitins, polysulfonic acids, polyhydroxy methacrylates, polyvinyl pyrrolidones, poly-N-vinyl acetamides, polyacrylamides, polyethyleneimines, polyallylamines, polyvinylamines, and the like are preferable. Copolymers of these compounds can also be used preferably.

As the water-absorbing polymer, a polymer including a repeating unit derived from vinyl alcohol, a polymer including a repeating unit derived from ethyleneimine, and a polymer including a repeating unit derived from acrylic acid are preferable. From the viewpoint of membrane strength, a polymer including a repeating unit derived from vinyl alcohol is more preferable.

Particularly, a vinyl alcohol-acrylic acid salt copolymer is preferable as the water-absorbing polymer. Vinyl alcohol-acrylic acid salt copolymers have high water absorbing ability, and in addition, even at the time of high water absorption, the strength of the gel membrane that has absorbed water and retains moisture is great. The content ratio of polyacrylic acid salt in the vinyl alcohol-acrylic acid salt copolymer is, for example, from 1 mol % to 95 mol %, preferably from 2 mol % to 70 mol %, more preferably from 3 mol % to 60 mol %, and particularly preferably from 5 mol % to 50 mol %. Examples of the polyacrylic acid salt include an alkali metal salt such as a sodium salt or a potassium salt, an ammonium salt, and an organic ammonium salt.

An example of a commercially available vinyl alcohol-acrylic acid salt copolymer (sodium salt) is KURASTMER AP20 (trade name, manufactured by Kuraray Co., Ltd.).

In the coating liquid for forming a carbon dioxide separation layer in the invention, any one of the water-absorbing polymers may be used singly, or two or more kinds thereof may be used in combination.

Although it depends on the kind, the content of the water-absorbing polymer in the coating liquid for forming a carbon dioxide separation layer is preferably from 0.5% by mass to 50% by mass, more preferably from 1% by mass to 30% by mass, and particularly preferably from 2% by mass to 15% by mass, with respect to the total mass of the coating liquid for forming a carbon dioxide separation layer, from the viewpoint of forming a membrane as a binder and providing a complex for carbon dioxide separation which can sufficiently retain moisture.

(Alkali Metal Salt)

The alkali metal salt included in the coating liquid for forming a carbon dioxide separation layer in the invention may be any substance that has affinity with carbon dioxide and exhibits water solubility, and known substances can be used.

Examples of the alkali metal salt include an alkali metal carbonate, an alkali metal hydrogencarbonate, an alkali metal hydroxide, and an aqueous solution obtained by adding a multidentate ligand that forms a complex with an alkali metal ion to an aqueous solution containing an alkali metal carbonate and/or an alkali metal hydrogencarbonate and/or an alkali metal hydroxide.

Examples of the alkali metal carbonate include lithium carbonate, sodium carbonate, potassium carbonate, rubidium carbonate, and cesium carbonate.

Examples of the alkali metal hydrogencarbonate include lithium hydrogencarbonate, sodium hydrogencarbonate, potassium hydrogencarbonate, rubidium hydrogencarbonate, and cesium hydrogencarbonate.

Examples of the alkali metal hydroxide include lithium hydroxide, sodium hydroxide, potassium hydroxide, cesium hydroxide, and rubidium hydroxide.

Among them, alkali metal carbonates are preferable, and compounds which contain cesium, rubidium, or potassium and have high solubility are preferable.

As the multidentate ligand that forms a complex with an alkali metal ion, a conventionally known multidentate ligand, for example: a cyclic polyether such as 12-crown-4, 15-crown-5, 18-crown-6, benzo-12-crown-4, benzo-15-crown-5, benzo-18-crown-6, dibenzo-12-crown-4, dibenzo-15-crown-5, dibenzo-18-crown-6, dicyclohexyl-12-crown-4, dicyclohexyl-15-crown-5, dicyclohexyl-18-crown-6, n-octyl-12-crown-4, n-octyl-15-crown-5, or n-octyl-18-crown-6; a cyclic polyether amine such as cryptand[2.1] or cryptand[2.2]; a bicyclic polyether amine such as cryptand[2.2.1] or cryptand[2.2.2]; porphyrin, phthalocyanine, polyethylene glycol, ethylenediamine tetraacetic acid, or the like, can be used.

In the coating liquid for forming a carbon dioxide separation layer in the invention, any one of the alkali metal salts may be used singly, or two or more kinds thereof may be used in combination.

Although it depends on the kind, the content of the alkali metal salt in the coating liquid for forming a carbon dioxide separation layer is preferably from 0.3% by mass to 30% by mass, more preferably from 0.5% by mass to 25% by mass, and particularly preferably from 1% by mass to 20% by mass, with respect to the total mass of the coating liquid for forming a carbon dioxide separation layer, in order to prevent salting-out before coating and to reliably exhibit the function of separation of carbon dioxide.

(Specific Filler)

The coating liquid for forming a carbon dioxide separation layer in the invention includes a filler (hereinafter also referred to as “specific filler”) having a density lower than the density of the alkali metal salt, a new Mohs hardness of 2 or more, and a volume average particle diameter that is 30% or less of the thickness of the carbon dioxide separation layer.

Since the density of the specific filler included in the coating liquid for forming a carbon dioxide separation layer is lower than the density of the alkali metal salt, it is presumed that the specific filler is unevenly distributed at the surface during the formation of the carbon dioxide separation layer. Further, since the hardness of the specific filler is high, it is presumed that a sufficient membrane strength can be achieved and the scratch resistance of the complex for carbon dioxide separation can be improved. Moreover, since the volume average particle diameter is 30% or less of the thickness of the carbon dioxide separation layer, it is presumed that the denseness can be maintained in the lower layer of the carbon dioxide separation layer and a high gas separation characteristic with respect to carbon dioxide can also be maintained.

It is enough that the density of the specific filler is lower than the density of the alkali metal salt. Specifically, from the viewpoint of realizing uneven distribution at the surface of the carbon dioxide separation layer, in a case in which water at 4° C. is taken as standard, a specific filler having a specific gravity of 4.1 or less is preferable, a specific filler having a specific gravity of 3.8 or less is more preferable, and a specific filler having a specific gravity of 3.5 or less is still more preferable.

Regarding the hardness of the specific filler, the new Mohs hardness is 2 or more. In a case in which the new Mohs hardness of the filler is less than 2, even if the filler is compounded, the complex for carbon dioxide separation cannot obtain sufficient strength.

Further, from the viewpoint of the membrane strength, the new Mohs hardness of the specific filler is preferably 2.5 or more, and more preferably 3.0 or more.

The volume average particle diameter of the specific filler is 30% or less of the thickness of the carbon dioxide separation layer. In a case in which the volume average particle diameter of the filler is greater than 30% of the thickness of the carbon dioxide separation layer, the filler is less likely to be distributed unevenly at the surface of the carbon dioxide separation layer, voids that originate in the space between the carbon dioxide separation layer and the filler particles are easily formed, and such defects that make it possible to allow gas to pass through the carbon dioxide separation layer are likely to occur, which is thus not preferable. The volume average particle diameter of the specific filler is preferably 20% or less of the thickness of the carbon dioxide separation layer, and more preferably 10% or less of the thickness of the carbon dioxide separation layer.

The film thickness of the carbon dioxide separation layer is determined as follows. Namely, the thickness of the entire carbon dioxide separation complex and the thickness of the support are measured using a micrometer manufactured by Mitutoyo Corporation, and the difference is calculated as the film thickness of the carbon dioxide separation layer.

Although it depends on the thickness of the carbon dioxide separation layer, the volume average particle diameter of the specific filler, in terms of the value of volume average particle diameter D50, is preferably from 0.005 μm to 50 μm, more preferably from 0.005 μm to 20 μm, and still more preferably from 0.005 μm to 10 μm, from the viewpoint of retaining the denseness of the carbon dioxide separation layer.

In the invention, the volume average particle diameter of the specific filler is measured as follows. Namely, the filler is added to a water medium, and then the mixture is thoroughly stirred under ultrasonic wave, to prepare a sample for measurement in which the filler is evenly dispersed at a concentration of about 100 ppm. This sample is subjected to measurement using a laser diffraction/scattering particle size distribution analyzer (manufactured by Beckman Coulter, Inc.).

The specific filler may be any substance that has a density, a hardness, and a volume average molecular weight each within the above ranges, respectively, and either an inorganic filler or an organic filler may be used. Further, an inorganic filler and an organic filler may be used by mixing them.

As the inorganic filler, a known inorganic filler can be used. Specific examples include metals and metal compounds (oxides, complex oxides, hydroxides, carbonic acid salts, sulfuric acid salts, silicic acid salts, phosphoric acid salts, nitrides, carbides, and composites of two or more of these compounds).

Further, silica, clay, kaolin, mica, smectite, zinc oxide, alumina, potassium titanate, aluminum borate, magnesium oxide, aluminium hydroxide, magnesium hydroxide, basic magnesium sulfate, calcium carbonate, calcium silicate, aluminum nitride, boron nitride, or any composite compound including two or more of these compounds can be used as the inorganic filler.

Among them, silica, alumina, aluminium hydroxide, magnesium oxide, magnesium hydroxide, calcium carbonate, boron nitride, clay, kaolin, mica are preferable, and silica, alumina, magnesium oxide and the like are more preferable, from the viewpoints of the density and hardness. The new Mohs hardnesses and particle specific gravities of the representative inorganic fillers, which can be used in the complex for carbon dioxide separation in the invention, are shown in the following Table 1.

TABLE 1

| Inorganic Filler | New Mohs Hardness | Particle Specific Gravity |
|---|---|---|
| Silica | 7 | 2.4 |
| Alumina | 12 | 3.8 |
| Aluminium hydroxide | 3 | 2.7 |
| Magnesium oxide | 6 | 3.6 |
| Magnesium hydroxide | 2.5 | 2.4 |
| Calcium carbonate | 3 | 2.7 |
| Boron nitride | 2 | 2.3 |
| Clay | 2 | 2.5 |
| Kaolin | 2.8 | 2.6 |
| Mica | 3 | 2.8 |

As the inorganic filler, an inorganic filler in which the surface of the filler has been treated with a surface modifying agent including an organic segment can be used, for the purpose of improving the affinity with the water-absorbing polymer contained in the carbon dioxide separation layer.

As the surface modifying agent including an organic segment, a known surface modifying agent can be used. Examples thereof include alkoxysilanes such as tetraethyl orthosilicate.

As the organic filler, a known organic filler such as a synthetic polymer resin or a natural polymer resin can be used.

Specific examples of the organic filler include particles formed from an acrylic resin, polytetrafluoroethylene, polyvinylidene fluoride, polyethylene, polypropylene, polyethylene oxide, polypropylene oxide, polyethyleneimine, polystyrene, polysiloxane, polycellulose acetate, polycarbonate, carboxymethyl cellulose, chitin, chitosan, or the like.

Among these organic fillers, an acrylic resin and polystyrene (PS) are particularly preferable, from the viewpoints of the density and hardness.

Further, from the viewpoints of the hardness and durability, the organic filler is preferably an inner part-crosslinked body. The new Mohs hardnesses and particle specific gravities of the representative organic fillers, which can be used in the complex for carbon dioxide separation in the invention, are shown in the following Table 2.

TABLE 2

| Organic Filler | New Mohs Hardness | Particle Specific Gravity |
|---|---|---|
| Acrylic resin | 4 | 1.2 |
| Polystyrene (PS) | 3 | 1.1 |

In the coating liquid for forming a carbon dioxide separation layer in the invention, any one of the specific fillers may be used singly, or two or more kinds thereof may be used in combination.

Although it depends on the kind, the content of the specific filler in the coating liquid for forming a carbon dioxide separation layer is preferably from 0.1% by mass to 10% by mass, more preferably from 0.3% by mass to 8% by mass, and particularly preferably from 0.5% by mass to 5% by mass, with respect to the total mass of the coating liquid for forming a carbon dioxide separation layer, from the viewpoint of membrane strength.

Further, the content of the specific filler with respect to the solids of the water-absorbing polymer described above is preferably from 1% by mass to 350% by mass, more preferably from 5% by mass to 200% by mass, and particularly preferably from 10% by mass to 100% by mass, on the basis of mass.

(Additional Component)

The coating liquid for forming a carbon dioxide separation layer in the invention may include one or more additional components, other than the water-absorbing polymer, the alkali metal salt, or the specific filler, to the extent of not exerting any influence on the membrane strength of the carbon dioxide separation layer and the like.

Examples of the additional components include a polysaccharide, a crosslinking agent, a carbon dioxide carrier other than an alkali metal salt, and further, a surfactant, a catalyst, a moisture-holding (water-absorbing) agent, an auxiliary solvent, a membrane strength adjusting agent, and a defect detecting agent.

(Polysaccharide)

The coating liquid for forming a carbon dioxide separation layer in the invention may further include a polysaccharide.

As the polysaccharide, any polysaccharide may be used without any limitation as far as a gel membrane (set membrane) having a high film thickness uniformity can be formed by coating, on a support, a coating liquid for forming a carbon dioxide separation layer and cooling the thus formed coated film.

Examples of the polysaccharide, which may be used, include a starch, a cellulose, agarose, xanthan gum, guar gum, glucomannan, curdlan, carrageenan, xanthan gum, gellan gum, dextran, locust bean gum, an alginic acid, and a hyaluronic acid. From the viewpoints of film forming property, availability, cost, membrane strength, and the like, agar is preferable.

Examples of a commercially available product include INA AGAR UP-37, UM-11S, SY-8, ZY-4, and ZY-6 (all trade names, manufactured by Ina Food Industry Co., Ltd.), and AGAROSE H and AGAROSE S (all trade names, manufactured by NIPPON GENE CO., LTD.).

In the coating liquid for forming a carbon dioxide separation layer in the invention, the polysaccharides may be used singly or in mixture of two or more kinds thereof. Among these polysaccharides, those having a function of increasing the gelation ability by mixing are known, and such a polysaccharide can be mixed and used as a gelation agent in order to adjust the gelation speed, the gelation ability, or the gelation temperature.

Further, the polysaccharide, which may be used in the invention, can also serve as a water-absorbing polymer. In this case, the amount used is determined according to the amount used and content ratio of the water-absorbing polymer.

Any one of the polysaccharides may be used singly, or two or more kinds thereof may be used in combination.

Regarding the content of the polysaccharide in the coating liquid for forming a carbon dioxide separation layer, although it depends on the kind, when the content of the polysaccharide is too large, there are cases in which the coating liquid becomes highly viscous in a short time such that coating becomes difficult, and there is a possibility that coating defects may occur. Further, from the viewpoint of suppressing the lowering of uniformity in film thickness, the content of the polysaccharide is preferably 10% by mass or less, more preferably from 0.1% by mass to 8% by mass, and still more preferably from 0.3% by mass to 5% by mass, with respect to the total mass of the coating liquid for forming a carbon dioxide separation layer.

(Crosslinking Agent)

Crosslinking of the water-absorbing polymer can be carried out by using a conventionally known technique such as heat crosslinking, ultraviolet ray crosslinking, electron beam crosslinking, or radiation crosslinking. It is preferable that the coating liquid for forming a carbon dioxide separation layer in the invention includes a crosslinking agent. Particularly, it is preferable to include a crosslinking agent having two or more functional groups capable of performing heat crosslinking by reacting with a vinyl alcohol-acrylic acid salt copolymer. Preferable examples of the crosslinking agent include a polyvalent glycidyl ether, a polyhydric alcohol, a polyvalent isocyanate, a polyvalent aziridine, a haloepoxy compound, a polyvalent aldehyde, and a polyvalent amine.

Here, examples of the polyvalent glycidyl ether include ethylene glycol diglycidyl ether, polyethylene glycol diglycidyl ether, glycerol polyglycidyl ether, diglycerol polyglycidyl ether, polyglycerol polyglycidyl ether, sorbitol polyglycidyl ether, pentaerythritol polyglycidyl ether, propylene glycol glycidyl ether, and polypropylene glycol diglycidyl ether.

Examples of the polyhydric alcohol include ethylene glycol, diethylene glycol, triethylene glycol, tetraethylene glycol, polyethylene glycol, glycerin, polyglycerin, propylene glycol, diethanolamine, triethanolamine, polyoxypropyl, an oxyethylene oxypropylene block copolymer, pentaerythritol, and sorbitol.

Examples of the polyvalent isocyanate include 2,4-toluoylene diisocyanate and hexamethylene diisocyanate. Further, examples of the polyvalent aziridine include 2,2-bishydroxymethylbutanol-tris[3-(1-aziridinyl)propionate], 1,6-hexamethylenediethylene urea, and diphenylmethane-bis-4,4′-N,N′-diethylene urea.

Examples of the haloepoxy compound include epichlorohydrin and α-methylchlorohydrin.

Further, examples of the polyvalent aldehyde include glutaraldehyde and glyoxal.

Moreover, examples of the polyvalent amine include ethylenediamine, diethylenetriamine, triethylenetetramine, tetraethylenepentamine, pentaethylenehexamine, and polyethyleneimine.

Among the above crosslinking agents, as a heat crosslinking agent for the vinyl alcohol-acrylic acid salt copolymer, glutaraldehyde is particularly preferable.

Any one of the crosslinking agents may be used singly, or two or more kinds thereof may be used in combination.

Although it depends on the kind, the content of the crosslinking agent is preferably from 0.0001% by mass to 5% by mass, more preferably from 0.001% by mass to 1% by mass, and still more preferably from 0.002% by mass to 0.5% by mass, with respect to the total mass of the coating liquid for forming a carbon dioxide separation layer, from the viewpoints of the membrane strength, durability, and separation performance of the carbon dioxide separation layer.

(Additional Carbon Dioxide Carrier)

The coating liquid for forming a carbon dioxide separation layer in the invention may include a known carbon dioxide carrier, other than the alkali metal salt described above.

The additional carbon dioxide carrier is a component other than the above-described alkali metal salt, and various water-soluble inorganic or organic substances that have affinity with carbon dioxide and exhibit basic properties can be used.

Examples of the additional carbon dioxide carrier include ammonia, an ammonium salt, a straight-chain amine, a cyclic amine, an amine salt, alkanolamine, and an ammonium salt. Further, water-soluble derivatives of these compounds can also be used preferably.

From the viewpoint that the carrier can be retained in the complex for carbon dioxide separation for a long period of time, an amine-containing compound which hardly evaporates, such as an amino acid or a betaine, is particularly preferable.

Examples of the alkanolamine may include various water-soluble alkanolamines such as monoethanolamine, diethanolamine, triethanolamine, monopropanolamine, dipropanolamine, or tripropanolamine.

As the amino acid, glycine, alanine, serine, proline, histidine, cysteine, taurine, diaminopropionic acid, phosphoserine, sarcosine, dimethylglycine, β-alanine, 2-aminoisobutyric acid, or the like can be used, regardless of the presence or absence in nature. Further, a peptide in which several amino acids are linked together may also be used. Note that, in the case of a hydrophobic amino acid, the amino acid causes phase separation with a hydrophilic gel membrane and, as a result, the permeability of gas other than carbon dioxide is also raised; however, since hydrophilic amino acids have high solubility and high affinity with water-absorbing polymers and polysaccharides, a hydrophilic amino acid is particularly preferable. Specifically, the Log P value (P: partition coefficient to an octanol-water system), which is an index showing the hydrophilicity and hydrophobicity of an amino acid, is preferably −1.5 or less, more preferably −2.0 or less, and particularly preferably −2.5 or less. Examples of an amino acid having a Log P value of −2.5 or less include arginine, lycine, aspartic acid, glutamic acid, glutamine, histidine, proline, serine, threonine, glycine, alanine, diaminopropionic acid, and taurine.

The Log P value of an amino acid can be estimated by a computational chemical method or an empirical method. Concerning the calculation method, there are a Crippen's fragmentation method (J. Chem. Inf. Comput. Sci., 27, 21 (1987).), a Viswanadhan's fragmentation method (J. Chem. Inf. Comput. Sci., 29, 163 (1989).), a Broto's fragmentation method (Eur. J. Med. Chem.-Chim. Theor., 19, 71 (1984).), and the like; however, in the invention, in a case in which the log P value of a compound differs according to the measurement method or the calculation method, the value is judged by the Crippen's fragmentation method.

Specifically, the amino acid is preferably arginine, lycine, aspartic acid, glutamic acid, glutamine, histidine, proline, serine, threonine, glycine, alanine, diaminopropionic acid, or taurine, more preferably glycine, serine, alanine, diaminopropionic acid, or taurine, and particularly preferably glycine or serine.

It is preferable to use an alkali metal carbonate, among the alkali metal salts, and an amino acid in combination, from the viewpoint of enhancing the carbon dioxide permeation speed and separation factor. In particular, it is preferable to add a hydrophilic amino acid to one or more of cesium carbonate, rubidium carbonate, or potassium carbonate. Above all, it is preferable to use glycine and/or serine. It is thought that, by adding an amino acid, in addition to an alkali metal carbonate, a path for absorption and desorption of carbon dioxide by the amino acid is also formed, and thus permeation of carbon dioxide is accelerated.

Examples of the betaine include carnitine and trimethylglycine. Particularly, trimethylglycine is preferable.

Any one of the additional carbon dioxide carriers may be used singly, or two or more kinds thereof may be used in mixture.

Although it depends on the kind, the content of the additional carbon dioxide carrier in the coating liquid for forming a carbon dioxide separation layer is preferably from 0.001% by mass to 10% by mass, more preferably from 0.01% by mass to 8% by mass, and particularly preferably from 0.1% by mass to 5% by mass, with respect to the total mass of the coating liquid for forming a carbon dioxide separation layer, in order to prevent salting-out before coating and to reliably exhibit the function of separation of carbon dioxide.

(Method of Preparing Coating Liquid for Forming Carbon Dioxide Separation Layer)

It is preferable that the coating liquid for forming a carbon dioxide separation layer is prepared by adding the above-described water-absorbing polymer, alkali metal salt, and specific filler, and further, if necessary, additional components, each in an appropriate amount, to water (normal temperature water, heated water, or hot aqueous solution at a temperature of 85° C. or higher), stirring the mixture sufficiently, and, if necessary, heating the mixture while stirring to accelerate dispersion.

The water-absorbing polymer, the alkali metal salt, and the specific filler may be separately added to water, or a mixture obtained by mixing them in advance may be added to water.

For example, the water-absorbing polymer and the alkali metal salt may be added to water to obtain a dispersion, and then the specific filler is gradually added thereto and stirred, whereby deposition of the water-absorbing polymer can be effectively prevented.

In the case of adding a polysaccharide as the additional component, it is preferable to use hot water at a temperature of 85° C. or higher, from the viewpoint of preventing deposition of the polysaccharide.

[Drying Process]

In the drying process, the coating liquid for forming a carbon dioxide separation layer, which has been applied onto the support, is dried to obtain a carbon dioxide separation layer.

Warm air is applied to the gel membrane on the support 12 which has been conveyed to the drying section 40, to perform drying.

The velocity of air is preferably a velocity with which the gel membrane can be rapidly dried and which does not cause collapse of the gel membrane, and is preferably, for example, from 1 m/min to 80 m/min, more preferably from 2 m/min to 70 m/min, and particularly preferably from 3 m/min to 60 m/min.

The temperature of the air is such that the temperature of the membrane surface is preferably from 1° C. to 80° C., more preferably from 2° C. to 70° C., and particularly preferably from 3° C. to 60° C., for the purpose of not causing deformation of the support or the like, and rapidly drying the coating liquid for forming a carbon dioxide separation layer.

[Other Process]

The method for manufacturing a complex for carbon dioxide separation in the invention may include, other than the application process or the drying process, one or more other processes, if necessary.

(Cooling Process)

In a case in which a polysaccharide is contained in the coating liquid or the like, it is preferable to include a cooling process before the drying process, from the viewpoint of adjusting the viscosity of the coating liquid to fall within a more preferable range. Further, since the membrane after the cooling process is fixed in a gel state, drying is carried out without causing collapse, even though the air for drying is applied, and also from this point of view, it is preferable to carry out the drying process after the cooling process. However, in a case in which a coating liquid that has a viscosity suitable for application is used, the cooling process is not absolutely necessary.

In the cooling process, the coating liquid for forming a carbon dioxide separation layer that has been obtained on the support 12 in the application process is cooled to obtain a gel membrane.

The support having the coating liquid applied thereon is conveyed to the cooling section 30 and is instantly cooled, whereby the coating liquid is gelated (fixed) due to the solidification function of the polysaccharide included in the coating liquid, and thus a stable gel membrane (set membrane) is obtained.

When the cooling temperature in the cooling process is too high, it may take a long time for fixing and the film thickness uniformity may be deteriorated, and when the cooling temperature is too low, the gel membrane may freeze and thus, the membrane quality may be changed. In order to obtain a gel membrane in which the thickness of the coating liquid that has been applied is almost maintained, the cooling temperature in the cooling process may be determined according to the components of the coating liquid and the concentration (particularly, the type and concentration of polysaccharide), but from the viewpoint of rapidly gelating the coating liquid on the support 12 to form a gel membrane, the cooling temperature in the cooling process, in terms of the wet-bulb temperature, is preferably 35° C. or lower, specifically, from 1° C. to 35° C., more preferably from 2° C. to 20° C., and particularly preferably from 5° C. to 15° C.

Further, the passage time in the cooling process is preferably from 1 second to 200 seconds, more preferably from 20 seconds to 150 seconds, and particularly preferably from 30 seconds to 100 seconds, from the viewpoints of improvement in productivity and the like.

As described above, after the application of the coating liquid for forming a carbon dioxide separation layer in the invention to the support, the coating liquid can be rapidly gelated to be converted into a gel membrane, and therefore, the film thickness of the carbon dioxide separation layer can be controlled with high accuracy. Accordingly, a complex for carbon dioxide separation which has a large film thickness and has a uniform thickness can be formed, and a complex for carbon dioxide separation which has a high gas separation characteristic can be manufactured with high productivity.

(Crosslinking Process)

The crosslinking process and the drying process may be performed simultaneously or may be performed separately. Alternatively, the crosslinking process may be performed at the time of preparation of the coating liquid for forming a carbon dioxide separation layer before the application process. Regarding the crosslinking technique, a known crosslinking technique can be used. For example, crosslinking may be performed by using a heating means such as an infrared heater or the like, after drying the gel membrane by applying warm air thereto; or drying and crosslinking may be performed simultaneously using warm air. Heat crosslinking can be conducted, for example, by heating to a temperature of from about 100° C. to about 150° C. The gel membrane after coating may be subjected to UV or electron beam crosslinking, and then dried. Further, a complex for carbon dioxide separation may be obtained by performing crosslinking, after winding up the dried membrane obtained through the drying process onto the take-up roll 50.

(Complex for Carbon Dioxide Separation)

By going through the processes described above, a complex for carbon dioxide separation according to the invention is obtained. The carbon dioxide separation layer in the complex for carbon dioxide separation contains the water-absorbing polymer, the alkali metal salt, and the specific filler.

From the viewpoint of the membrane strength, it is preferable that, in the complex for carbon dioxide separation, 60% by mass or more of the total mass of the specific filler exist within a region from the surface on the opposite side from the surface that contacts the support to the position at a depth of 50% in the film thickness direction of the carbon dioxide separation layer. Further, it is more preferable that 65% by mass or more of the total mass of the specific filler exist within the region, and it is still more preferable that 70% by mass or more of the total mass of the specific filler exist within the region.

As described above, in the carbon dioxide separation layer in the invention, according to the relationship between the specific gravities of the alkali metal salt and the specific filler, the specific filler is unevenly distributed in the vicinity of the surface at the time of application and drying of the coating liquid for forming a carbon dioxide separation layer.

An example of a method for more reliably distributing the specific filler unevenly in the vicinity of the surface is a method of performing multilayer coating by coating, on the support, a coating liquid that does not include the specific filler but includes the water-absorbing polymer and the alkali metal salt, and then superposing the coating liquid for forming a carbon dioxide separation layer. The coating liquid including the water-absorbing polymer and the alkali metal salt and the coating liquid for forming a carbon dioxide separation layer may be coated successively or simultaneously. By performing multilayer coating as described above, since the specific filler having a smaller specific gravity never sinks to the lower layer, the degree of uneven distribution of the specific filler in the vicinity of the surface of the carbon dioxide separation layer can be easily controlled by the coating amounts of both the coating liquid including the water-absorbing polymer and the alkali metal salt and the coating liquid for forming a carbon dioxide separation layer, and the content of the specific filler to be compounded into the coating liquid for forming a carbon dioxide separation layer.

In the invention, the localization of the specific filler in the carbon dioxide separation layer is confirmed as follows. Namely, the coating liquid for forming a carbon dioxide separation layer, which has been prepared, is coated on a porous support made of PTFE (trade name: QL217EXPG, manufactured by GE Energy Japan K.K.; 100 μm in thickness) by using an applicator, such that the thickness of the coated film becomes 1 mm, followed by drying, to prepare a sample for measurement. Then, a cross section perpendicular to the coated surface is cut out, and the cross section is observed using a scanning electron microscope (SEM-EDX) manufactured by JEOL Ltd. Specifically, from the SEM image of the cross section, energy dispersive X-ray analysis (EDX-mapping) is carried out, and the cross-sectional area occupied by the filler within a region from the surface on the opposite side from the surface that contacts the support to the position at a depth of 50%, in the carbon dioxide separation layer, is calculated, and from the proportion, the localization of the specific filler is confirmed.

In the surface of the carbon dioxide separation layer according to the invention, it is preferable that the membrane surface scratch damage initiation load when using a sapphire needle having a diameter of 0.5 mm is 20 g or more. The membrane surface scratch damage initiation load is more preferably 25 g or more, and still more preferably 30 g or more.

In the invention, the membrane surface scratch damage initiation load is determined as follows. Namely, the coating liquid for forming a carbon dioxide separation layer, which has been prepared, is coated on a porous support made of PTFE (trade name: QL217EXPG, manufactured by GE Energy Japan K.K.; 100 μm in thickness) by using an applicator, such that the thickness of the coated film becomes 1 mm, followed by drying, to prepare a sample for measurement. Measurement is conducted according to the method described in JIS K 5600-5-5. Specifically, using a continuous loading scratching intensity tester manufactured by Shinto Scientific Co., Ltd. (HEIDON), scratching is carried out at a velocity of 10 mm/sec using a sapphire needle having a diameter of 0.5 mm, and the presence or absence of scratch-induced damage on the membrane surface when the weight is changed is visually observed.

The compounding ratio of the coating liquid is reflected in the composition ratio of the components in the carbon dioxide separation layer.

The content of each component of the complex for carbon dioxide separation in the dried state is preferably within the range described below. Namely, the content of the water-absorbing polymer is preferably from 5% by mass to 90% by mass, more preferably from 10% by mass to 85% by mass, and still more preferably from 15% by mass to 80% by mass.

The content of the alkali metal salt is preferably from 5% by mass to 90% by mass, more preferably from 10% by mass to 85% by mass, and still more preferably from 20% by mass to 80% by mass.

The content of the specific filler is preferably from 1% by mass to 50% by mass, more preferably from 3% by mass to 45% by mass, and still more preferably from 5% by mass to 35% by mass.

For example, in the case of using a compound containing cesium as the alkali metal salt, from the viewpoint of improvement in carbon dioxide separation characteristics, the content of the compound containing cesium in the complex for carbon dioxide separation in the dried state is preferably 30% by mass or higher, more preferably 35% by mass or higher, and particularly preferably 40% by mass or higher.

Further, in the case of using, for example, a compound containing potassium as the alkali metal salt, the content of the compound containing potassium in the complex for carbon dioxide separation in the dried state is preferably 2% by mass or higher, more preferably 3% by mass or higher, and particularly preferably 5% by mass or higher.

Furthermore, in the case of using, for example, a compound containing cesium or potassium, as the alkali metal salt, and an amino acid, the content of the amino acid with respect to the carbon dioxide separation layer in the dried state is preferably 2% by mass or higher, more preferably 3% by mass or higher, and particularly preferably 5% by mass or higher.

After forming the complex for carbon dioxide separation, if necessary, a carrier elution prevention layer may be provided on the complex for carbon dioxide separation, in order to prevent elution of the alkali metal salt or additional carbon dioxide carrier. The carrier elution prevention layer preferably has a nature of permeating gas such as carbon dioxide, steam, or the like, but not permeating water or the like, and is preferably a hydrophobic porous membrane. A membrane having such a nature may be coated on the membrane surface, or a membrane that has been separately prepared may be laminated.

<Complex for Carbon Dioxide Separation>

The complex for carbon dioxide separation of the invention includes a water-absorbing polymer, an alkali metal salt, and a filler having a density lower than the density of the alkali metal salt, a new Mohs hardness of 2 or more, and a volume average particle diameter that is 30% or less of the thickness of the carbon dioxide separation layer.

As for the water-absorbing polymer, the alkali metal salt, and the specific filler, the matters described above can be applied.

<Module for Carbon Dioxide Separation>

The module for carbon dioxide separation of the invention is a module equipped with a complex for carbon dioxide separation. As for the complex for carbon dioxide separation, the matters described in the above paragraph <Complex for Carbon Dioxide Separation> can be applied without modification.

In the module for carbon dioxide separation of the invention, the complex for carbon dioxide separation may be provided as a flat membrane, or may be utilized by processing into a spiral wound type, a pleated type, or the like, which is known as a reverse osmosis module.

### EXAMPLES

Hereinafter, the present invention is specifically described with reference to Examples; however, the present invention is by no means limited to the following Examples unless they are beyond the spirit of the invention.

### Example 1

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of silica (trade name: ST-30, manufactured by Nissan Chemical Industries, Ltd.) were added thereto, thereby preparing a coating liquid for forming a carbon dioxide separation layer.

The thus prepared coating liquid for forming a carbon dioxide separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 2

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 2.0% by mass of silica (trade name: ST-30, manufactured by Nissan Chemical Industries, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 3

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of silica (trade name: ST-ZL, manufactured by Nissan Chemical Industries, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 4

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of silica (trade name: MP-4540M, manufactured by Nissan Chemical Industries, Ltd.) were added thereto, thereby preparing a coating liquid for forming a separation layer.

The thus prepared coating liquid for forming a carbon dioxide separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 5

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.75% by mass of silica (trade name: KE-P 100, manufactured by Nippon Shokubai Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 6

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of silica (trade name: KE-P 100, manufactured by Nippon Shokubai Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 7

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.75% by mass of silica (trade name: KE-S250, manufactured by Nippon Shokubai Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 8

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.5% by mass of alumina (trade name: LS-242C, manufactured by Nippon Light Metal Company, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 9

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of alumina (trade name: LS-242C, manufactured by Nippon Light Metal Company, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 10

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 2% by mass of alumina (trade name: LS-242C, manufactured by Nippon Light Metal Company, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 11

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.5% by mass of aluminium hydroxide (trade name: BF-103, manufactured by Nippon Light Metal Company, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 12

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of aluminium hydroxide (trade name: BF-103, manufactured by Nippon Light Metal Company, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 13

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 2.0% by mass of aluminium hydroxide (trade name: B-703, manufactured by Nippon Light Metal Company, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 14

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.75% by mass of magnesium oxide (trade name: SMO, manufactured by Sakai Chemical Industry Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 15

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of magnesium oxide (trade name: SMO, manufactured by Sakai Chemical Industry Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 16

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.75% by mass of magnesium oxide (trade name: SMO, manufactured by Sakai Chemical Industry Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 17

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.5% by mass of magnesium hydroxide (trade name: PZ-1, manufactured by Tateho Chemical Industries Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 18

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of magnesium hydroxide (trade name: PZ-1, manufactured by Tateho Chemical Industries Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 19

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of calcium carbonate (trade name: VISCOEXCEL-30, manufactured by SHIRAISHI CALCIUM KAISHA, LTD.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 20

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 2.0% by mass of calcium carbonate (trade name: VISCOEXCEL-30, manufactured by SHIRAISHI CALCIUM KAISHA, LTD.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 21

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of calcium carbonate (trade name: VIGOT-10, manufactured by SHIRAISHI CALCIUM KAISHA, LTD.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 22

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.5% by mass of boron nitride (trade name: UHP-1, manufactured by SHOWA DENKO K.K.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 23

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.75% by mass of clay (trade name: ST-301, manufactured by SHIRAISHI CALCIUM KAISHA, LTD.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 24

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of clay (trade name: ST-301, manufactured by SHIRAISHI CALCIUM KAISHA, LTD.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 25

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.5% by mass of clay (trade name: ST-100, manufactured by SHIRAISHI CALCIUM KAISHA, LTD.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 26

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.5% by mass of mica (trade name: MK-100, manufactured by Co-op Chemical Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 27

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of mica (trade name: MK-100, manufactured by Co-op Chemical Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 28

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.75% by mass of acrylic resin (PMMA; trade name: MP-2200, manufactured by Soken Chemical & Engineering Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 29

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of acrylic resin (PMMA; trade name: MP-2200, manufactured by Soken Chemical & Engineering Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 30

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 2.0% by mass of acrylic resin (PMMA; trade name: MP-2200, manufactured by Soken Chemical & Engineering Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 31

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 0.5% by mass of polystyrene (trade name: SX350H, manufactured by Soken Chemical & Engineering Co., Ltd.; PS) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 32

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of polystyrene (trade name: SX350H, manufactured by Soken Chemical & Engineering Co., Ltd.; PS) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 33

A hot aqueous solution (temperature: 85° C. or higher) containing 0.5% by mass of agar (trade name: INA AGAR UP-37, manufactured by Ina Food Industry Co., Ltd.), 2.5% by mass of polyvinyl alcohol (trade name: PVA-117, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of silica (trade name: ST-30, manufactured by Nissan Chemical Industries, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 34

A hot aqueous solution (temperature: 85° C. or higher) containing 0.5% by mass of agar (trade name: INA AGAR UP-37, manufactured by Ina Food Industry Co., Ltd.), 2.5% by mass of polyvinyl alcohol (trade name: PVA-117, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 2.0% by mass of silica (trade name: ST-30, manufactured by Nissan Chemical Industries, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 35

A hot aqueous solution (temperature: 85° C. or higher) containing 0.5% by mass of agar (trade name: INA AGAR UP-37, manufactured by Ina Food Industry Co., Ltd.), 2.5% by mass of polyvinyl alcohol (trade name: PVA-117, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of silica (trade name: ST-ZL, manufactured by Nissan Chemical Industries, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 36

A hot aqueous solution (temperature: 85° C. or higher) containing 0.5% by mass of agar (trade name: INA AGAR UP-37, manufactured by Ina Food Industry Co., Ltd.), 2.5% by mass of polyvinyl alcohol (trade name: PVA-117, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of magnesium oxide (trade name: SMO, manufactured by Sakai Chemical Industry Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 37

A hot aqueous solution (temperature: 85° C. or higher) containing 0.5% by mass of agar (trade name: INA AGAR UP-37, manufactured by Ina Food Industry Co., Ltd.), 2.5% by mass of polyvinyl alcohol (trade name: PVA-117, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of calcium carbonate (trade name: VISCOEXCEL-30, manufactured by SHIRAISHI CALCIUM KAISHA, LTD.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 38

A hot aqueous solution (temperature: 85° C. or higher) containing 0.5% by mass of agar (trade name: INA AGAR UP-37, manufactured by Ina Food Industry Co., Ltd.), 2.5% by mass of polyvinyl alcohol (trade name: PVA-117, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of acrylic resin (PMMA; trade name: MP-2200, manufactured by Soken Chemical & Engineering Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 39

A hot aqueous solution (temperature: 85° C. or higher) containing 0.5% by mass of agar (trade name: INA AGAR UP-37, manufactured by Ina Food Industry Co., Ltd.), 2.5% by mass of polyethyleneimine (trade name: EPOMIN P-1000, manufactured by NIPPON SHOKUBAI CO., LTD.), 6.0% by mass of cesium carbonate (manufactured by Kisan Kinzoku Chemicals Co, Ltd.), and 0.2% by mass of glutaraldehyde was prepared, and further, 1.25% by mass of silica (trade name: ST-30, manufactured by Nissan Chemical Industries, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 40

A hot aqueous solution (temperature: 85° C. or higher) containing 0.5% by mass of agar (trade name: INA AGAR UP-37, manufactured by Ina Food Industry Co., Ltd.), 2.5% by mass of polyethyleneimine (trade name: EPOMIN P-1000, manufactured by NIPPON SHOKUBAI CO., LTD.), 6.0% by mass of cesium carbonate (manufactured by Kisan Kinzoku Chemicals Co, Ltd.), and 0.2% by mass of glutaraldehyde was prepared, and further, 2.0% by mass of silica (trade name: ST-30, manufactured by Nissan Chemical Industries, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 41

A hot aqueous solution (temperature: 85° C. or higher) containing 0.5% by mass of agar (trade name: INA AGAR UP-37, manufactured by Ina Food Industry Co., Ltd.), 2.5% by mass of polyethyleneimine (trade name: EPOMIN P-1000, manufactured by NIPPON SHOKUBAI CO., LTD.), 6.0% by mass of cesium carbonate (manufactured by Kisan Kinzoku Chemicals Co, Ltd.), and 0.2% by mass of glutaraldehyde was prepared, and further, 1.25% by mass of silica (trade name: ST-ZL, manufactured by Nissan Chemical Industries, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 42

A hot aqueous solution (temperature: 85° C. or higher) containing 0.5% by mass of agar (trade name: INA AGAR UP-37, manufactured by Ina Food Industry Co., Ltd.), 2.5% by mass of polyethyleneimine (trade name: EPOMIN P-1000, manufactured by NIPPON SHOKUBAI CO., LTD.), 6.0% by mass of cesium carbonate (manufactured by Kisan Kinzoku Chemicals Co, Ltd.), and 0.2% by mass of glutaraldehyde was prepared, and further, 1.25% by mass of magnesium oxide (trade name: SMO, manufactured by Sakai Chemical Industry Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 43

A hot aqueous solution (temperature: 85° C. or higher) containing 0.5% by mass of agar (trade name: INA AGAR UP-37, manufactured by Ina Food Industry Co., Ltd.), 2.5% by mass of polyethyleneimine (trade name: EPOMIN P-1000, manufactured by NIPPON SHOKUBAI CO., LTD.), 6.0% by mass of cesium carbonate (manufactured by Kisan Kinzoku Chemicals Co, Ltd.), and 0.2% by mass of glutaraldehyde was prepared, and further, 1.25% by mass of calcium carbonate (trade name: VISCOEXCEL-30, manufactured by SHIRAISHI CALCIUM KAISHA, LTD.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Example 44

A hot aqueous solution (temperature: 85° C. or higher) containing 0.5% by mass of agar (trade name: INA AGAR UP-37, manufactured by Ina Food Industry Co., Ltd.), 2.5% by mass of polyethyleneimine (trade name: EPOMIN P-1000, manufactured by NIPPON SHOKUBAI CO., LTD.), 6.0% by mass of cesium carbonate (manufactured by Kisan Kinzoku Chemicals Co, Ltd.), and 0.2% by mass of glutaraldehyde was prepared, and further, 0.75% by mass of acrylic resin (PMMA; trade name: MP-2200, manufactured by Soken Chemical & Engineering Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Comparative Example 1

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Comparative Example 2

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of zirconium oxide (manufactured by Wako Pure Chemical Industries, Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

### Comparative Example 3

A hot aqueous solution (temperature: 85° C. or higher) containing 0.5% by mass of agar (trade name: INA AGAR UP-37, manufactured by Ina Food Industry Co., Ltd.), 2.5% by mass of vinyl alcohol-acrylic acid salt copolymer (sodium salt; trade name: KURASTMER AP20, manufactured by Kuraray Co., Ltd.), 6.0% by mass of cesium carbonate (manufactured by Kisan Kinzoku Chemicals Co, Ltd.), and 0.2% by mass of glutaraldehyde was prepared, and further, 1.25% by mass of talc (trade name: K-1, manufactured by Nippon Talc Co., Ltd.) were added thereto, thereby preparing a coating liquid for forming a carbon dioxide separation layer.

The thus prepared coating liquid for forming a separation layer was coated on a porous support made of PTFE (trade name: QL217EXPG, manufactured by GE Energy Japan K.K.; 100 μm in thickness) by a roll-to-roll system, and then cooled such that the temperature of the membrane surface was 35° C. or lower, followed by drying, to form a membrane. The resulting substance was wound up into a roll, to obtain a complex for carbon dioxide separation.

The characteristics and the like of the components in the complexes for carbon dioxide separation according to Examples 1 to 44 and Comparative Examples 1 to 3 prepared as described above are shown altogether in Table 3 and Table 4 below.

In Table 3 and Table 4, the addition amount (% by weight) indicates the addition amount of the specific filler with respect to the solids of the water-absorbing polymer.

In Table 3 and Table 4, the outer layer content ratio (%) indicates the proportion of the specific filler that exists within the region from the surface on the opposite side from the surface that contacts the support to the position at a depth of 50% in the film thickness direction of the carbon dioxide separation layer.

[Film Thickness Measuring Method]

The film thicknesses of the carbon dioxide separation layers prepared in Examples 1 to 44 and Comparative Example 1 to 3 were each determined as follows. Namely, the thickness of the entire carbon dioxide separation complex and the thickness of the support were measured using a micrometer manufactured by Mitutoyo Corporation, and the difference was calculated as the film thickness of the carbon dioxide separation layer.

[Evaluation]

—Evaluation of Gas Separation Properties—

Using the complexes for carbon dioxide separation prepared in Examples 1 to 44 and Comparative Examples 1 to 3, evaluation in regard to the performance for separation of carbon dioxide gas in the respective complexes was performed as described below. The results are shown in Table 3 and Table 4.

The complex was cut, together with the support, into a piece having a diameter of 47 mm, and was put between two sheets of PTFE membrane filter, to produce a permeation test sample.

As the test gas, a mix gas of CO₂/H₂: 10/90 (volume ratio) was supplied at a relative humidity of 70%, a flow rate of 500 mL/min, a temperature of 130° C., and a total pressure of 301.3 kPa, to each of the samples (effective area: 2.40 cm²) described above, and an Ar gas (flow rate: 90 mL/min) was made to flow on the permeation side. The gas that had been permeated was analyzed by gas chromatography, and the CO₂ permeation speed (Q(CO₂)) and the separation factor α were calculated. Evaluation was performed according to the criteria described below.

The CO₂ permeation speed (Q(CO₂)) was calculated according to the following formula: 1 GPU=1×10⁻⁵ mol·m²·s⁻¹·kPa⁻¹.

The separation factor α was calculated according to the following formula: Separation factor α=Q(CO₂)/Q(H₂).

—Evaluation Criteria of CO₂ Permeation Speed (Q(CO₂))—

A: Q(CO₂) is 130 GPU or more.

B: Q(CO₂) is 60 GPU or more but less than 130 GPU.

C: Q(CO₂) is less than 60 GPU.

—Evaluation Criteria of Separation Factor α—

A: 300 or more

B: less than 300

—Evaluation of Membrane Strength—

Using the complexes for carbon dioxide separation prepared in Examples 1 to 44 and Comparative Examples 1 to 3, evaluation in regard to the membrane strength (scratch strength) in the respective complexes was performed as described below. The results are shown in Table 3 and Table 4.

With regard to the surface of the complex for carbon dioxide separation, a scratch test using a sapphire needle having a diameter of 0.5 mm was performed, and visual observation was performed.

Specifically, using a continuous loading scratching intensity tester manufactured by Shinto Scientific Co., Ltd. (HEIDON), scratching was carried out at a velocity of 10 mm/sec using a sapphire needle having a diameter of 0.5 mm, and the presence or absence of scratch-induced damage on the membrane surface when the weight was changed was visually observed.

—Evaluation Criteria—

A: The membrane surface scratch damage initiation load is 50 g or more.

B: The membrane surface scratch damage initiation load is 20 g or more but less than 50 g.

C: The membrane surface scratch damage initiation load is less than 20 g.

TABLE 3

| | Composition of CO₂ Separation Film | | | | | | | | | | | | | |
|---|---|---|---|---|---|---|---|---|---|---|---|---|---|---|
| | | | | Filler | | | | | | | CO₂ | Evaluation | | |
| | | | | | | | | | Ad. | O. | S. Lay. | Sep. | | |
| | W. Ab. | Alk. Met Salt | | | | AvPD | Mohs | | Amt | rate | Thick. | Q(CO₂) | Sep. | M. St. |
| Ex. | Polym | Kind | Grav | Trade name | Kind | (μm) | H. | Grav | (wt %) | (%) | (μm) | (GPU) | α | Sc. St |
| 1 | PV-PA. | CeCO₃ | 4.1 | ST-30 | Silica | 0.01 | 7 | 2.4 | 5. | 91 | 35 | A | A | A |
| 2 | PV-PA. | CeCO₃ | 4.1 | ST-30 | Silica | 0.01 | 7 | 2.4 | 80 | 84 | 35 | B | A | A |
| 3 | PV-PA. | CeCO₃ | 4.1 | ST-ZL | Silica | 0.1 | 7 | 2.4 | 50 | 82 | 35 | A | A | A |
| 4 | PV-PA. | CeCO₃ | 4.1 | MP-4540M | Silica | 0.5 | 7 | 2.4 | 50 | 76 | 37 | A | A | A |
| 5 | PV-PA. | CeCO₃ | 4.1 | KE-P100 | Silica | 1.1 | 7 | 2.4 | 30 | 78 | 37 | A | A | A |
| 6 | PV-PA. | CeCO₃ | 4.1 | KE-P100 | Silica | 1.1 | 7 | 2.4 | 50 | 74 | 39 | A | A | A |
| 7 | PV-PA. | CeCO₃ | 4.1 | KE-S250 | Silica | 2.2 | 7 | 2.4 | 30 | 73 | 42 | A | A | B |
| 8 | PV-PA. | CeCO₃ | 4.1 | LS-242C | Alumina | 2 | 12 | 3.8 | 20 | 78 | 42 | A | A | A |
| 9 | PV-PA. | CeCO₃ | 4.1 | LS-242C | Alumina | 2 | 12 | 3.8 | 50 | 72 | 44 | A | A | B |
| 10 | PV-PA. | CeCO₃ | 4.1 | LS-242C | Alumina | 2 | 12 | 3.8 | 80 | 65 | 42 | B | A | B |
| 11 | PV-PA. | CeCO₃ | 4.1 | BF-103 | Al hydroxide | 1.2 | 3 | 2.7 | 20 | 91 | 37 | A | A | B |
| 12 | PV-PA. | CeCO₃ | 4.1 | BF-103 | Al hydroxide | 1.2 | 3 | 2.7 | 50 | 86 | 39 | A | A | A |
| 13 | PV-PA. | CeCO₃ | 4.1 | B-703 | Al hydroxide | 3.5 | 3 | 2.7 | 20 | 82 | 38 | A | A | B |
| 14 | PV-PA. | CeCO₃ | 4.1 | SMO | Mg oxide | 0.1 | 6 | 3.6 | 30 | 81 | 35 | A | A | B |
| 15 | PV-PA. | CeCO₃ | 4.1 | SMO | Mg oxide | 0.1 | 6 | 3.6 | 50 | 74 | 36 | A | A | A |
| 16 | PV-PA. | CeCO₃ | 4.1 | SMO | Mg oxide | 1 | 6 | 3.6 | 30 | 71 | 37 | A | A | B |
| 17 | PV-PA. | CeCO₃ | 4.1 | PZ-1 | Mg hydroxide | 1.2 | 2.5 | 2.4 | 20 | 89 | 37 | A | A | B |
| 18 | PV-PA. | CeCO₃ | 4.1 | PZ-1 | Mg hydroxide | 1.2 | 2.5 | 2.4 | 50 | 74 | 39 | A | A | A |
| 19 | PV-PA. | CeCO₃ | 4.1 | Viscoexcel-30 | Ca carbonate | 0.03 | 3 | 2.7 | 50 | 89 | 35 | A | A | A |
| 20 | PV-PA. | CeCO₃ | 4.1 | Viscoexcel-30 | Ca carbonate | 0.03 | 3 | 2.7 | 80 | 79 | 35 | B | A | A |
| 21 | PV-PA. | CeCO₃ | 4.1 | Vigot 10 | Ca carbonate | 0.1 | 3 | 2.7 | 50 | 81 | 36 | A | A | A |
| 22 | PV-PA. | CeCO₃ | 4.1 | UHP-1 | B nitride | 8 | 2 | 2.3 | 20 | 75 | 48 | A | A | B |
| 23 | PV-PA. | CeCO₃ | 4.1 | ST-301 | Clay | 0.7 | 2 | 2.5 | 30 | 87 | 37 | A | A | B |
| 24 | PV-PA. | CeCO₃ | 4.1 | ST-301 | Clay | 0.7 | 2 | 2.5 | 50 | 78 | 38 | A | A | B |

TABLE 4

| | Composition of CO₂ Separation Film | | | | | | | | | | | | | |
|---|---|---|---|---|---|---|---|---|---|---|---|---|---|---|
| | | | | Filler | | | | | | | CO₂ | Evaluation | | |
| | | | | | | | | | Ad. | O. | S. Lay. | Sep. | | |
| | W. Ab. | Alk. Met Salt | | | | AvPD | Mohs | | Amt | rate | Thick. | Q(CO₂) | Sep. | M. St. |
| Ex. | Polym. | Kind | Grav | Trade name | Kind | (μm) | H. | Grav | (wt %) | (%) | (μm) | (GPU) | α | Sc. St |
| 25 | PV-PA. | CeCO₃ | 4.1 | ST-100 | Clay | 3.5 | 2 | 2.5 | 20 | 83 | 43 | A | A | B |
| 26 | PV-PA. | CeCO₃ | 4.1 | MK-100 | Mica | 4 | 3 | 2.8 | 20 | 85 | 44 | A | A | B |
| 27 | PV-PA. | CeCO₃ | 4.1 | MK-100 | Mica | 4 | 3 | 2.8 | 30 | 79 | 46 | A | A | A |
| 28 | PV-PA. | CeCO₃ | 4.1 | MP-2200 | PMMA | 0.3 | 4 | 1.2 | 30 | 95 | 38 | A | A | A |
| 29 | PV-PA. | CeCO₃ | 4.1 | MP-2200 | PMMA | 0.3 | 4 | 1.2 | 50 | 91 | 39 | B | A | A |
| 30 | PV-PA. | CeCO₃ | 4.1 | MP-2200 | PMMA | 0.3 | 4 | 1.2 | 80 | 83 | 41 | B | A | A |
| 31 | PV-PA. | CeCO₃ | 4.1 | SX350H | PS | 3.5 | 3 | 1.1 | 20 | 89 | 47 | A | A | B |
| 32 | PV-PA. | CeCO₃ | 4.1 | SX350H | PS | 3.5 | 3 | 1.1 | 50 | 81 | 52 | B | A | A |
| 33 | PVA. | CeCO₃ | 4.1 | ST-30 | Silica | 0.01 | 7 | 2.4 | 50 | 92 | 35 | B | A | A |
| 34 | PVA. | CeCO₃ | 4.1 | ST-30 | Silica | 0.01 | 7 | 2.4 | 80 | 82 | 35 | C | B | A |
| 35 | PVA. | CeCO₃ | 4.1 | ST-ZL | Silica | 0.1 | 7 | 2.4 | 50 | 80 | 36 | B | A | A |
| 36 | PVA. | CeCO₃ | 4.1 | SMO | Mg oxide | 0.1 | 6 | 3.6 | 50 | 71 | 36 | B | A | A |
| 37 | PVA. | CeCO₃ | 4.1 | Viscoexcel-30 | Ca carbonate | 0.03 | 3 | 2.7 | 50 | 90 | 35 | B | A | A |
| 38 | PVA. | CeCO₃ | 4.1 | MP-2200 | PMMA | 0.3 | 4 | 1.2 | 30 | 89 | 38 | B | A | A |
| 39 | PEI. | CeCO₃ | 4.1 | ST-30 | Silica | 0.01 | 7 | 2.4 | 50 | 89 | 35 | B | A | A |
| 40 | PEI. | CeCO₃ | 4.1 | ST-30 | Silica | 0.01 | 7 | 2.4 | 80 | 81 | 35 | C | B | A |
| 41 | PEI. | CeCO₃ | 4.1 | ST-ZL | Silica | 0.1 | 7 | 2.4 | 50 | 77 | 36 | B | A | A |
| 42 | PEI. | CeCO₃ | 4.1 | SMO | Mg oxide | 0.1 | 6 | 3.6 | 50 | 72 | 36 | B | A | A |
| 43 | PEI. | CeCO₃ | 4.1 | Viscoexcel-30 | Ca carbonate | 0.03 | 3 | 2.7 | 50 | 88 | 35 | B | A | A |
| 44 | PEI. | CeCO₃ | 4.1 | MP-2200 | PMMA | 0.3 | 4 | 1.2 | 30 | 88 | 38 | B | A | A |
| C1 | PV-PA. | CeCO₃ | 4.1 | none | none | — | — | — | — | — | 35 | A | A | C |
| C2 | PV-PA. | CeCO₃ | 4.1 | Zr oxide | Zr oxide | 0.5 | 9 | 5.5 | 50 | 32 | 38 | A | A | C |
| C3 | PV-PA. | CeCO₃ | 4.1 | K-1 | Talc | 8 | 1 | 2.8 | 20 | 84 | 47 | A | A | C |

In tables 3 and 4, the abbreviation “Ex.” represents “Example Number”, the abbreviation “C1”, “C2” and “C3” respectively represents “Comparative Example-1”, “Comparative Example-2” and “Comparative Example-3”, the abbreviation “W. Ab. Polym.” represents “Water-absorbing polymer”, the abbreviation “Alk. Met Salt” represents “Alkali metal salt”, the abbreviation “Gray” represents “Gravity”, the abbreviation “AvPD” represents “Average particle diameter”, the abbreviation “Mohs H.” represents “New Mohs hardness”, the abbreviation “Ad. Amt” represents “Addition amount”, the abbreviation “O. rate” represents “Outer layer content ratio”, the abbreviation “CO₂ S. Lay. Thick.” represents “Film thickness of the carbon dioxide separation layer”, “Sep.” represents “Performance for separation”, the abbreviation “M. St.” represents “Membrane Strength”, the abbreviation “Sep. α” represents “Separation factor α”, and the abbreviation “Sc. St.” represents “Scratch strength”.

From the results shown in Table 3 and Table 4, it has become clear that each of the complexes for carbon dioxide separation of the examples had excellent membrane strength.

### Example 45

### Preparation of Module

Using the complex for carbon dioxide separation prepared in Example 1, and referring to JP-A No. H5-168869, a spiral wound type module was prepared. It was confirmed that the thus prepared module for carbon dioxide separation had excellent performance for separation of carbon dioxide, in accordance with the performance of the complex for carbon dioxide separation incorporated.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling others skilled in the art to understand the invention for various embodiments and with the various modifications as are suited to the particular use contemplated.

Japanese Patent Application No. 2012-155924 filed Jul. 11, 2012, is hereby expressly incorporated by reference, in its entirety, into the present application. All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. A method for manufacturing a complex for carbon dioxide separation, the complex for carbon dioxide separation comprising a support and a carbon dioxide separation layer on the support, and the method comprising:
applying, on the support, a coating liquid for forming the carbon dioxide separation layer, the coating liquid comprising:
a water-absorbing polymer,
an alkali metal salt, and
a filler having a density lower than a density of the alkali metal salt, a new Mohs hardness of 2 or greater, and a volume average particle diameter that is 30% or less of a thickness of the carbon dioxide separation layer; and
drying the applied coating liquid for forming the carbon dioxide separation layer to obtain the carbon dioxide separation layer.

2. The method for manufacturing a complex for carbon dioxide separation according to claim 1, wherein 60% by mass or more of a total mass of the filler exists within a region from a surface on an opposite side from a surface that contacts the support to a position at a depth of 50% in a film thickness direction of the carbon dioxide separation layer.

3. The method for manufacturing a complex for carbon dioxide separation according to claim 1, wherein a membrane surface scratch damage initiation load at a surface of the carbon dioxide separation layer, when a sapphire needle having a diameter of 0.5 mm is used, is 20 g or more.

4. The method for manufacturing a complex for carbon dioxide separation according to claim 1, wherein the filler is at least one selected from the group consisting of an inorganic filler and an organic filler.

5. The method for manufacturing a complex for carbon dioxide separation according to claim 1, wherein the filler is at least one of (i) an inorganic filler containing silica, alumina, aluminium hydroxide, magnesium oxide, magnesium hydroxide, calcium carbonate, boron nitride, clay, kaolin or mica, or (ii) an organic filler containing an acrylic resin particle or a polystyrene particle.

6. The method for manufacturing a complex for carbon dioxide separation according to claim 1, wherein the water-absorbing polymer is at least one polymer selected from the group consisting of a polymer comprising a repeating unit derived from vinyl alcohol, a polymer comprising a repeating unit derived from an ethylene imine, and a polymer comprising a repeating unit derived from an acrylic acid.

7. The method for manufacturing a complex for carbon dioxide separation according to claim 1, wherein the water-absorbing polymer is a polymer comprising a repeating unit derived from vinyl alcohol.

8. The method for manufacturing a complex for carbon dioxide separation according to claim 1, wherein the water-absorbing polymer is a vinyl alcohol-acrylic acid copolymer.

9. The method for manufacturing a complex for carbon dioxide separation according to claim 1, wherein the coating liquid for forming the carbon dioxide separation layer further comprises a polysaccharide at a content of from 0.1% by mass to 8% by mass with respect to a total mass of the coating liquid for forming a carbon dioxide separation layer.

10. The method for manufacturing a complex for carbon dioxide separation according to claim 9, wherein the polysaccharide is an agar.

11. The method for manufacturing a complex for carbon dioxide separation according to claim 1, wherein the coating liquid for forming the carbon dioxide separation layer further comprises a crosslinking agent at a content of from 0.001% by mass to 1% by mass with respect to a total mass of the coating liquid for forming a carbon dioxide separation layer.

12. The method for manufacturing a complex for carbon dioxide separation according to claim 11, wherein the crosslinking agent is glutaraldehyde.

13. The method for manufacturing a complex for carbon dioxide separation according to claim 1, wherein the applying is coating, on the support in a single layer, the coating liquid for forming the carbon dioxide separation layer, or coating, on the support in a multilayer, a coating liquid comprising the water-absorbing polymer and the alkali metal salt, and the coating liquid for forming the carbon dioxide separation layer, in this order.

14. The method for manufacturing a complex for carbon dioxide separation according to claim 1, wherein the method further comprises cooling the coating liquid for forming the carbon dioxide separation layer, obtained on the support in the applying, to a temperature in a range of from 1° C. to 35° C., before the drying.

15. A complex for carbon dioxide separation, the complex being obtained by the method for manufacturing a complex for carbon dioxide separation according to claim 1.

16. A complex for carbon dioxide separation, the complex comprising:
a carbon dioxide separation layer, comprising:
a water-absorbing polymer,
an alkali metal salt, and
a filler having a density lower than a density of the alkali metal salt, and a new Mohs hardness of 2 or greater, wherein a volume average particle diameter is 30% or less of a thickness of the carbon dioxide separation layer.

17. The complex for carbon dioxide separation according to claim 16, wherein 60% by mass or more of a total mass of the filler exists within a region from a surface on an opposite side from a surface that contacts the support to a position at a depth of 50% in a film thickness direction of the carbon dioxide separation layer.

18. A carbon dioxide separation module, comprising a complex for carbon dioxide separation, the complex comprising:
a carbon dioxide separation layer comprising:
a water-absorbing polymer,
an alkali metal salt, and
a filler having a density lower than a density of the alkali metal salt, and a new Mohs hardness of 2 or greater, wherein a volume average particle diameter of the filler is 30% or less of a thickness of the carbon dioxide separation layer.

19. The method for manufacturing a complex for carbon dioxide separation according to claim 2, wherein the filler is at least one of (i) an inorganic filler containing silica, alumina, aluminium hydroxide, magnesium oxide, magnesium hydroxide, calcium carbonate, boron nitride, clay, kaolin or mica, or (ii) an organic filler containing an acrylic resin particle or a polystyrene particle, and wherein a membrane surface scratch damage initiation load at a surface of the carbon dioxide separation layer, when a sapphire needle having a diameter of 0.5 mm is used, is 20 g or more.

20. The method for manufacturing a complex for carbon dioxide separation according to claim 19, wherein the water-absorbing polymer is at least one polymer selected from the group consisting of a polymer comprising a repeating unit derived from vinyl alcohol, a polymer comprising a repeating unit derived from an ethylene imine, and a polymer comprising a repeating unit derived from an acrylic acid, and wherein the coating liquid for forming the carbon dioxide separation layer further comprises an agar, which is a polysaccharide, at a content of from 0.1% by mass to 8% by mass with respect to a total mass of the coating liquid for forming a carbon dioxide separation layer.

21. The method for manufacturing a complex for carbon dioxide separation according to claim 20, wherein the coating liquid for forming the carbon dioxide separation layer further comprises a glutaraldehyde, which is a crosslinking agent, at a content of from 0.001% by mass to 1% by mass with respect to a total mass of the coating liquid for forming a carbon dioxide separation layer.

22. The method for manufacturing a complex for carbon dioxide separation according to claim 21, wherein the applying is coating, on the support in a single layer, the coating liquid for forming the carbon dioxide separation layer, or coating, on the support in a multilayer, a coating liquid comprising the water-absorbing polymer and the alkali metal salt, and the coating liquid for forming the carbon dioxide separation layer, in this order.

23. The method for manufacturing a complex for carbon dioxide separation according to claim 22, wherein the method further comprises cooling the coating liquid for forming the carbon dioxide separation layer, obtained on the support in the applying, to a temperature in a range of from 1° C. to 35° C., before the drying.
